(19) United States
(12) Patent Application Publication
(10) Pub. No.: US 2006/0204678 A1
(43) Pub. Date: Sep. 14, 2006

(54) Optical film, liquid crystal panel including the same and liquid crystal display

(75) Inventors: Masaki Hayashi, Osaka (JP); Hiroyuki Yoshimi, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Nitto Denko Corporation, Ibaraki-shi (JP)

(21) Appl. No.: 10/556,401

(22) PCT Filed: Jun. 25, 2004
(86) PCT No.: PCT/JP04/09029

§ 371 Date: Nov. 10, 2005

(30) Foreign Application Priority Data
Aug. 7, 2003 (JP) 2003-289075

(51) Int. Cl. C09K 19/00

(52) U.S. Cl. 428/1.3

(57) ABSTRACT

An optical film whose retardation distribution is uniform, whose rainbow-like irregularity is suppressed, whose color is transparent and whose optical characteristics are extremely good is provided. A birefringent material containing a non-liquid crystal polymer is dissolved in methyl isobutyl ketone so as to prepare a coating solution. This coating solution is applied onto a transparent film, thus forming a coating film. By drying the coating film, an optical film having a birefringent layer formed on the transparent film is obtained. As the non-liquid crystal polymer, it is possible to use polyimide that has a birefringence (Δn_{xyz}) in a thickness direction when formed into a film of at least 0.03 and is soluble in methyl isobutyl ketone.

### TECHNICAL FIELD

The present invention relates to an optical film, a liquid crystal panel and a liquid crystal display using the same.

### BACKGROUND ART

Conventionally, in color TFT liquid crystal displays in various modes, retardation plates for optical compensation have been used widely for the purpose of achieving a higher contrast ratio over a wide viewing angle and improving color shifting. Typical retardation plates are, for example, stretched films of polycarbonate and norbornene-based polymer. However, since these stretched films have an extremely large thickness of about 25 to 100 μm and further achieve only a small retardation value in a narrow range, they have to be laminated repeatedly over each other for use as a retardation plate with sufficient characteristics. Therefore, in the case of mounting such a retardation plate on a liquid crystal display, there has been the following problem. That is, in spite of the fact that reduction in thickness and weight of liquid crystal displays is desired, the obtained display is thick and heavy and has reduced display characteristics due to optical axis displacement or decrease in transmittance caused by laminating the films.

Further, as a thin optical compensation layer, a laminate of a polarizing plate and a crystalline compound has been developed. More specifically, an optical compensation layer exhibiting a negative uniaxial birefringence formed of cholesteric liquid crystal (e.g., see Patent document 1) and a polarizing plate with a protective film to which a discotic liquid crystalline compound is applied (e.g., see Patent document 2), etc. have been disclosed, for example. Thanks to their high birefringence, liquid crystalline compounds help to reduce the thickness of the optical compensation layers. For forming a transparent film for optical compensation by using such liquid crystalline compounds, liquid crystal molecules have to be aligned uniformly. In order to align the liquid crystalline compound, an alignment layer or an alignment film for defining the orientation of alignment is absolutely necessary. The alignment film usually is formed by forming a film of polymer such as polyvinyl alcohol or polyimide on a base and then rubbing the film or by depositing an inorganic compound onto a base. Also, for the alignment film, PET (polyethylene terephthalate) preferably is used, for example. However, since the uniformity of the liquid crystalline compound is dependent on the kinds, uniformity and treatment conditions of the alignment layer or alignment film and susceptible to a surrounding environment, inclination irregularity and alignment irregularity occur easily, leading to a problem that the uniform alignment is extremely difficult to achieve in a wide area. Further, since many liquid crystalline compounds are not very soluble in organic solvents, limited kinds of solvents having a high solvency need to be used, leading to a problem that the kinds of a base for forming an optical compensation layer also is limited to kinds that are insoluble in these solvents. Accordingly, an optical compensation layer constituted by a liquid crystalline compound usually is formed by forming a film of the liquid crystalline compound on another base that has been treated to be aligned and then laminating only this film on a polarizing plate or by forming many layers of alignment layers and solvent permeation prevention layers on a transparent protective film of a polarizing plate and then applying a solution of the liquid crystalline compound to a surface of these layers. Therefore, the number of steps increases, leading to various problems such as lower yields, and deterioration of uniformity in external appearance.

Accordingly, in recent years, a film produced by casting a polyimide solution has been developed as an optical compensation layer exhibiting a negative uniaxial birefringence. More specifically, in order to improve the viewing angle characteristics of normally white twisted nematic (TN) liquid crystal displays, a negative uniaxial birefringent film using polyimide that can control optical characteristics by linearity and rigidity of a molecular skeleton has been disclosed (e.g., Patent document 3), and as a material of a similar negative uniaxial birefringent film, polyamide, polyester, polyesterimide, polyamide imide and copolymers thereof have been disclosed (e.g., Patent document 4). Since such thermoplastic polymers (non-liquid crystal polymers) have a voluntary molecular alignment property of themselves, an optically anisotropic layer can be produced by utilizing this property without using the above-mentioned alignment layers.

Such polymer materials tend to achieve a film with a higher birefringence in its thickness direction as the degrees of rigidity and linearity of their molecular skeleton increase. Thus, using polymer materials having a high birefringence, it is possible to obtain an excellent optical compensation layer that is still thinner and exhibits a sufficient retardation in the thickness direction.

However, such polymer materials having a high birefringence have very poor solubility in general organic solvents. Therefore, only limited kinds of solvent such as chloroform, dichloromethane, dimethylformamide, dimethylacetamide, N-chloroform, N-methyl-pyrrolidone and a mixture thereof can be used. Also, such polymer materials having a high birefringence tend to be colored, and the coloration may cause a problem in the optical characteristics thereof. Accordingly, these polymer materials are not suitable as optical materials.

Patent document 1: JP 2002-533784A

Patent document 2: JP Patent 2565644

Patent document 3: U.S. Pat. No. 5,344,916

Patent document 4: JP 10(1998)-508048A

### DISCLOSURE OF INVENTION

### Problem to be Solved by the Invention

As described above, there is a problem that, when a solvent having a high solvency is used as the solvent, the kind of a base to which a non-liquid crystal polymer solution is applied becomes limited. In other words, by applying the solution, the base is eroded by the solvent in the solution. Accordingly, it is necessary to use a base formed of a material that is not affected by the solvent. On the other hand, the inventors of the present invention separately have found that, since a non-liquid crystal polymer has a voluntary molecular alignment property as described above, it is possible to apply the polymer solution to any base regardless of whether it is an alignment substrate or a non-alignment substrate as long as the base does not impair the optical characteristics of the optical compensation layer, so as to form a laminate of the base and a birefringent layer and use the laminate as it is as an optical compensation plate. However, a TAC film or the like used as the base that does not impair the optical characteristics of the optical compensation layer may be eroded by the above-noted solvent. Accordingly, in practice, it sometimes has been desired that, after a birefringent layer is formed on a limited kind of bases, the birefringent layer alone should be laminated on the TAC film or the like. Because of the erosion of the base caused by the solvent and the coloration of the birefringent layer, although the non-liquid crystal polymer itself has a high birefringence in its thickness direction, the laminate obtained by forming the birefringent layer on the base has had a problem in external appearance such as cloud or cracks in the base, for example, and may not be commercialized as an optical film.

Accordingly, the object of the present invention is to provide an optical film, including a laminate of a base and a birefringent layer formed on the base, that has an excellent external appearance such as a transparency and achieves a high retardation in its thickness direction.

### Means for Solving Problem

In order to achieve the above-mentioned object, a method for producing an optical film according to the present invention is a method for producing an optical film including a birefringent layer and a transparent film. The method includes applying onto the transparent film a solution obtained by dissolving a birefringent material into a solvent, and forming the birefringent layer by hardening a formed coating film. The solvent is methyl isobutyl ketone (MIBK), and the birefringent material contains a non-liquid crystal polymer that has a birefringence (Δn_{xyz}) in a thickness direction represented by the equation below of at least 0.03 and is soluble in the MIBK. In the equation below, nx, ny and nz respectively represent refractive indices in an X-axis direction, a Y-axis direction and a Z-axis direction of a film when the non-liquid crystal polymer is formed into the film, with the X-axis direction being an axial direction exhibiting a maximum refractive index within a surface of the film, the Y-axis direction being an axial direction perpendicular to the X-axis direction within the surface and the Z-axis direction being a thickness direction perpendicular to the X-axis direction and the Y-axis direction.
Δn_{xyz}=[(nx+ny)/2]−nz

### EFFECTS OF THE INVENTION

The solvency of a solvent with respect to a polymer is generally known. For example, the solvency relationship between N,N-dimethylacetamide, cyclopentanone, ethyl acetate and MIBK is “N,N-dimethylacetamide>cyclopentanone>ethyl acetate>MIBK.” On the other hand, the birefringence in the thickness direction of the non-liquid crystal polymer varies depending on the kinds. It is known that the linearity and rigidity of the molecular skeleton increases with an increase in the birefringence in the thickness direction, making the non-liquid crystal polymer very difficult to dissolve in the solvent as described above. Therefore, in order to dissolve the non-liquid crystal polymer having a high birefringence in its thickness direction, it is well-known that a solvent having a high solvency such as N,N-dimethylacetamide is indispensable. Under such circumstances, the inventors of the present invention have carried out a keen study and found out a non-liquid crystal polymer that is soluble in a nonpolar MIBK with a very low solvency, even having a high birefringence in the thickness direction, namely, Δn_{xyz} of 0.03 or higher. The inventors of the present invention found for the first time that a non-liquid crystal polymer is soluble in a MIBK with a low solvency, in spite of the fact that the solvent has to have a high solvency in order to dissolve a non-liquid crystal polymer whose birefringence in the thickness direction is high as described above. Then, by using these non-liquid crystal polymer and MIBK, even when a solution of the non-liquid crystal polymer is applied to a base such as a TAC film, the base is not eroded by MIBK, which is the solvent, because MIBK has a low solvency in spite of the fact that the non-liquid crystal polymer can be dissolved in MIBK sufficiently. Consequently, even when a birefringent layer is formed on the base as described above, the problem in external appearance such as cloud in the resultant laminate or cracks in the base is solved. From the above, in accordance with the producing method of the present invention, even in the case of using a non-liquid crystal polymer having a birefringence in its thickness direction as high as Δn_{xyz} of 0.03 or higher, it is possible to obtain a laminate of a base and a birefringent layer formed on the base without causing any problem in external appearance. An optical film including such a laminate can achieve excellent display characteristics even when mounted on various image display apparatuses such as a liquid crystal display.

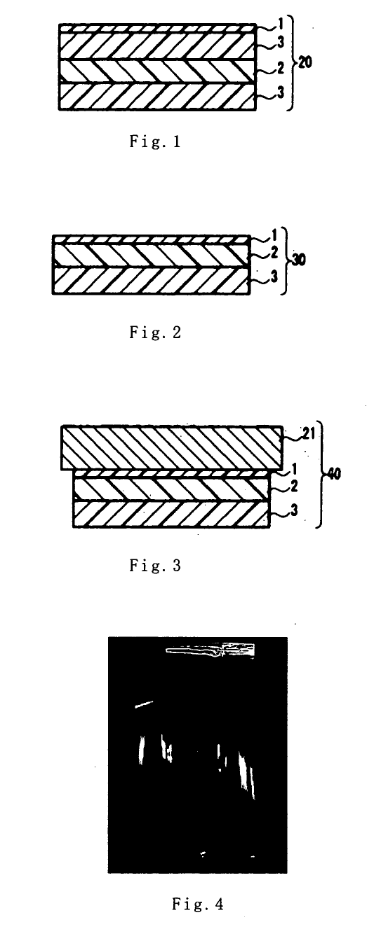

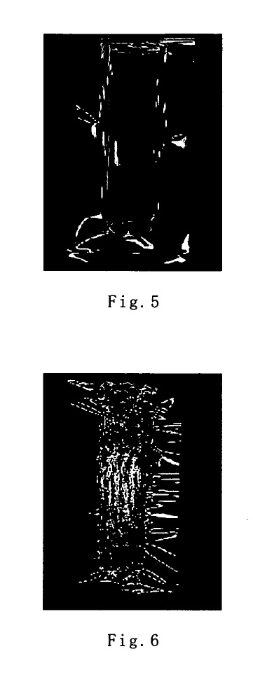

### BRIEF DESCRIPTION OF DRAWINGS

[FIG. 1] FIG. 1 is a sectional view showing an example of an optical film of the present invention.

[FIG. 2] FIG. 2 is a sectional view showing another example of the optical film of the present invention.

[FIG. 3] FIG. 3 is a sectional view showing an example of a liquid crystal panel of the present invention.

[FIG. 4] FIG. 4 is a photograph showing an optical film in Example of the present invention.

[FIG. 5] FIG. 5 is a photograph showing an optical film in Comparative Example.

[FIG. 6] FIG. 6 is a photograph showing an optical film in Comparative Example.

### BEST MODE FOR CARRYING OUT THE INVENTION

As described above, the method for producing an optical film according to the present invention is a method for producing an optical film including a birefringent layer and a transparent film. The method includes applying onto the transparent film a solution obtained by dissolving a birefringent material into a solvent, and forming the birefringent layer by hardening a formed coating film. The solvent is MIBK, and the birefringent material contains a non-liquid crystal polymer that has a birefringence (Δn_{xyz}) in a thickness direction represented by the equation below of at least 0.03 and is soluble in the MIBK. In the equation below, nx, ny and nz respectively represent refractive indices in an X-axis direction, a Y-axis direction and a Z-axis direction of a film when the non-liquid crystal polymer is formed into the film, with the X-axis direction being an axial direction exhibiting a maximum refractive index within a surface of the film, the Y-axis direction being an axial direction perpendicular to the X-axis direction within the surface and the Z-axis direction being a thickness direction perpendicular to the X-axis direction and the Y-axis direction.
Δn_{xyz}=[(nx+ny)/2]−nz

In the definition of the birefringence (Δn_{xyz}), “when the non-liquid crystal polymer is formed into the film” means, for example, the case of applying onto a base a solution obtained by dissolving a birefringent material into a solvent and forming a film by hardening the formed coating film, and the thickness of this film is not limited at all.

The birefringence in the thickness direction (Δn_{xyz}) of the non-liquid crystal polymer preferably is 0.03 to 0.1, more preferably is 0.04 to 0.1, further preferably is 0.05 to 0.1 and particularly preferably is 0.06 to 0.1.

The non-liquid crystal polymer is not particularly limited as long as it has a birefringence in its thickness direction of at least 0.03 and is a polymer that is soluble in MIBK as described above, and preferably is a polymer having excellent backbone rigidity, linearity and symmetry, for example, because a large retardation (Rth) in the thickness direction can be achieved. Such a polymer can be polyimide disclosed in, for example, U.S. Pat. No. 5,071,997, JP 8(1996)-511812 A or JP 10(1998)-508048 A and, in particular, polyimide having repeating units represented by the formulae (1) and (2) below. Among them, polyimide formed of the repeating unit of the formula (1) alone and polyimide formed of a repeating structural unit of the formula (2) alone are preferable. The polyimide formed of the repeating unit of the formula (1) or (2) is not colored when dissolved in the solvent and, therefore, is extremely useful for an optical film. Also, the polyimide formed of the repeating unit of the formula (2) is particularly preferable because a large retardation in the thickness direction can be achieved with a small thickness.

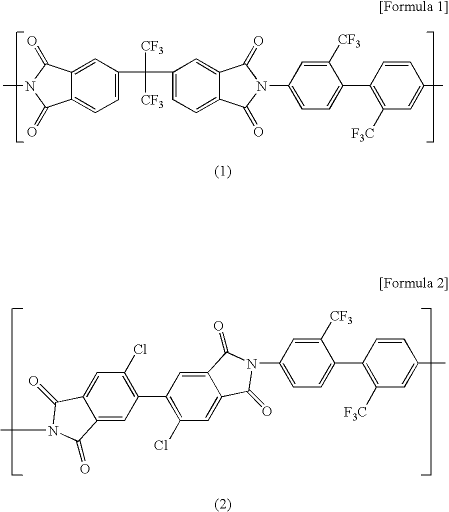

The polyimide formed of the repeating unit of the formula (1) alone has a birefringence in its thickness direction of, for example, 0.03 to 0.05, and the polyimide formed of the repeating structural unit of the formula (2) alone has a birefringence in its thickness direction of, for example, 0.05 to 0.1, preferably 0.06 to 0.085 and more preferably 0.061 to 0.084. These polyimides can be set to have a higher birefringence in the thickness direction Δn_{xyz} by increasing a molecular weight relatively, for example. The molecular weight of the polyimide can be adjusted, for example, by changing a reaction condition of synthesis by a conventionally known method.

The above-noted polyimide formed of the repeating unit of the formula (1) can be synthesized by a conventionally known method, for example, using 2,2′-bis(3,4-dicarboxyphenyl)hexafluoropropane acid dianhydride (6FDA) and 2,2′-bis(trifluoromethyl)-4,4′-diaminobiphenyl (PFMB) represented by the formulae below.

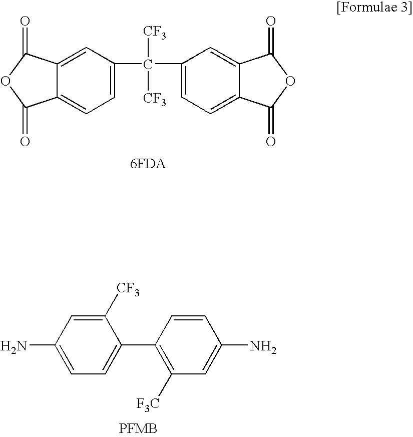

The above-noted polyimide formed of the repeating unit of the formula (2) was newly found by the inventors of the present invention as a non-liquid crystal polymer that is soluble in MIBK and has a birefringence in the thickness direction (Δn_{xyz}) of at least 0.03. In the following, an exemplary method for synthesizing the above-noted polyimide formed of the repeating unit of the formula (2) will be described.

First, as a monomer, 2,2′-dichloro-4,4′,5,5′-biphenyl tetracarboxylic acid dianhydride (DCBPDA) represented by the formula below is synthesized. It should be noted that this monomer was newly found by the inventors of the present invention in order to synthesize the above-noted polyimide formed of the repeating unit of the formula (2). Incidentally, Polymer Vol. 37, No. 22, pp. 5049-5057 (1996), for example, can be referred to for the method for synthesizing the monomer.

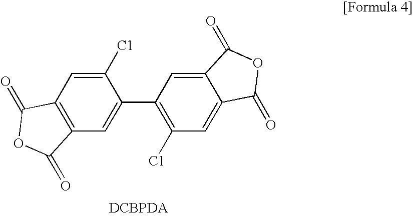

3,3′,4,4′-biphenyl tetracarboxylic acid dianhydride (BPDA) is dissolved in an NaOH solution. Then, this solution is heated up to 100° C., a chlorine gas further is injected into the solution, and 5 minutes after the gas injection, obtained white precipitate is dissolved again by adding an NaOH aqueous solution gradually thereto. Further, a chlorine gas is injected continuously into this solution, thereby forming precipitate again (temperature: 100° C.). After this solution is cooled down to room temperature, the precipitate is collected and subjected to a rinsing treatment and a drying treatment, thereby obtaining DCBTC-Na (2,2′-dichloro-4,4′,5,5′-biphenyl tetracarboxylic acid, sodium salt). This DCBTC-Na is suspended in an HCl aqueous solution and stirred at 90° C. After stirring, the reaction solution is cooled down to room temperature, and white precipitate is collected, thus obtaining DCBPTC (2,2′-dichloro-4,4′,5,5′-biphenyl tetracarboxylic acid). Further, by drying DCBPTC under reduced pressure to allow dehydration, DCBPDA (2,2′-dichloro-4,4′,5,5′-biphenyl tetracarboxylic acid dianhydride) is obtained.

Next, DCBPDA and 2,2′-bis(trifluoromethyl)-4,4′-diaminobiphenyl (PFMB) are allowed to react together to synthesize a polymer. First, after PFMB is dissolved completely in m-cresol, DCBPDA is added thereto and stirred under a nitrogen atmosphere. Furthermore, after isoquinoline is dropped into this solution, the solution is stirred while heating at about 200° C. and then cooled down to room temperature. This solution is diluted with m-cresol, and this diluted solution is dropped into vigorously stirred methanol, thereby forming a fibrous solid substance. This fibrous solid substance is collected, so that polyimide formed of the repeating unit of the formula (2) is obtained.

The weight-average molecular weight of this polyimide is, for example, 10,000 to 1,000,000 and preferably is 20,000 to 500,000. Polyimide having a weight-average molecular weight of 10,000 or larger has excellent strength when formed into a film, while that having a weight-average molecular weight of 1,000,000 or smaller also has an excellent solubility in MIBK. More specifically, in the case of the polyimide formed of the repeating unit of the formula (1), its weight-average molecular weight preferably ranges from 50,000 to 200,000, for example. Also, in the case of the polyimide formed of the repeating unit of the formula (2), its weight-average molecular weight preferably ranges from 50,000 to 200,000, for example.

It is noted that, unlike a liquid crystal material, with the non-liquid crystal polymer such as polyimide, a film exhibiting an optical uniaxiality of nx>nz and ny>nz can be formed thanks to its own property irrespective of the alignment of the substrate as described above. Therefore, the above-mentioned transparent film is not limited to a film with an alignment layer or an alignment film but can be a non-aligned film, so that the transparent film can be used as a constituent member of an optical film.

On the other hand, there is no particular limitation on a material for forming the transparent film as long as a birefringent layer can be formed on its surface and it can be used as it is as an optical film. In other words, even in the case where the transparent film is included as a constituent member of the optical film, any material that does not practically affect the optical characteristics of the birefringent layer may be used. Such a material preferably is a material having excellent transparency and can be, for example, cellulose-based resins such as triacetylcellulose (TAC), polyester-based resins, polycarbonate resins, polyamide resins, polyimide resins, polyethersulfone resins, polysulfone resins, polystyrene-based resins, norbornene-based resins, polyolefin resins, acrylic resins, acetate-based resins, polymethyl methacrylate-based resins and the like. As a transparent film made of the above-noted norbornene-based resins, trade name ARTON (manufactured by JSR Corporation), trade name ZEONOR (manufactured by ZEON Corporation) or the like can be used. Furthermore, as the material for the transparent film, it also is possible to use a mixture of a thermoplastic resin whose side chain has a substituted imido group or an unsubtituted imido group and a thermoplastic resin whose side chain has a substituted phenyl group or an unsubtituted phenyl group and a nitrile group as described in JP 2001-343529 A (WO 01/37007), for example. Specific examples thereof include a resin composition containing an alternating copolymer of isobutene and N-methyl maleimide and an acrylonitrile-styrene copolymer. Among these materials, a material that can set a relatively lower birefringence when the transparent film is formed is preferable. More specifically, the above-mentioned mixture of the thermoplastic resin whose side chain has a substituted imido group or an unsubtituted imido group and the thermoplastic resin whose side chain has a substituted phenyl group or an unsubtituted phenyl group and a nitrile group is preferable. Further, these transparent films may contain as a retardation adjusting agent an aromatic compound having at least two aromatic rings as described in EP 0911656A2, for example.

The transparent film usually has a thickness of 12 to 200 μm, preferably 20 to 150 μm and more preferably 25 to 100 μm. The transparent film with a thickness of equal to or larger than 12 μm achieves an even better application accuracy in an applying process described later, while the transparent film with a thickness of equal to or smaller than 200 μm improves an external appearance further when mounted on a liquid crystal cell, for example.

Next, an example of a method for producing an optical film according to the present invention will be described. It should be noted that the present invention is not particularly limited as long as it uses MIBK as the solvent as described earlier and materials described above as the birefringence forming material.

First, the birefringence forming material is dissolved in the solvent MIBK so as to prepare a coating solution. For an excellent applicability, the ratio of the non-liquid crystal polymer dissolved into MIBK is, for example, at least 5 parts by weight, preferably 5 to 50 parts by weight and more preferably 10 to 40 parts by weight with respect to 100 parts by weight MIBK.

The coating solution may contain a general polymer material or a liquid crystal material, for example, as a blend material other than the above-described non-liquid crystal polymer. Furthermore, an UV absorber, an antioxidant, a peroxide decomposing agent, a radical inhibitor, a metal deactivator, an acid capturing agent, a degradation preventing agent for amine or the like, a stabilizer, a plasticizer, metals, an antistatic agent, an additive for improving adhesiveness to the transparent film or the like may be blended therein.

Then, the coating solution is applied to the surface of the transparent film, thereby forming a coating film. The method for applying the coating solution is not particularly limited but can be, for example, spin coating, roller coating, flow coating, printing, dip coating, film flow-expanding, bar coating or gravure printing. It is noted that the application amount of the coating solution can be determined suitably according to the content of the non-liquid crystal polymer in the coating solution, a desired thickness of the birefringent layer, etc, for example.

Subsequently, the coating film on the transparent film is hardened. Since the non-liquid crystal polymer exhibits optical characteristics of nx>nz and ny>nz in itself regardless of whether or not the transparent film is aligned, the birefringent layer formed by hardening the coating film becomes an optically uniaxial layer, namely, a layer showing retardation in its thickness direction.

The coating film can be hardened by a drying treatment, for example. The condition therefor is not particularly limited but can be, for example, air-drying or heating (for example, at 40° C. to 350° C.). The drying treatment preferably is carried out in two stages consisting of, for example, a first drying treatment at 40° C. to 140° C. (preferably 40° C. to 120° C.) (also referred to as a pre-curing treatment) and a subsequent second drying treatment at 150° C. to 350° C. (also referred to as a post-curing treatment). In this manner, the pre-curing treatment carried out in the above-mentioned range achieves an even better uniformity of the external appearance, while the post-curing treatment carried out in the above-mentioned range can suppress further the deterioration of the film uniformity and transparency.

The MIBK remaining in the formed birefringent layer after the drying treatment may change the optical characteristics of the optical film over time in proportion to its amount. Thus, the remaining amount thereof preferably is not greater than 1.0 wt % and more preferably is not greater than 0.5 wt %, for example.

With the producing method described above, it is possible to obtain an optical film according to the present invention, including a transparent film and a birefringent layer formed on the transparent film, that is free from coloration, cloud or crack and has an extremely good external appearance. Since such an optical film has an excellent external appearance, it is possible to suppress the deterioration of the optical characteristics caused by poor external appearance, so that extremely good display characteristics can be achieved when this film is used for an image display apparatus such as a liquid crystal display, for example.

The birefringent layer in the above-described optical film has a total transmittance (T) of preferably at least 80% and more preferably at least 90% in a wavelength range from 400 to 800 nm. It is preferable that the above-noted range is satisfied when the surface reflection on both surfaces of the birefringent layer is included.

The birefringent layer in the optical film has a thickness of, for example, 0.2 to 20 μm, preferably 1 to 15 μm and more preferably 2 to 10 μm. If the birefringent layer has a thickness of equal to or larger than 0.2 μm, it has an extremely good function as an optical element. If the birefringent layer has a thickness of equal to or smaller than 20 μm, it has an extremely good uniformity.

Further, the above-described method for producing the optical film further may include, after the process of forming the birefringent layer by hardening the formed coating film, a process of stretching or shrinking the birefringent layer. By this stretching or shrinking treatment, it becomes possible to change further the optical characteristics of the birefringent layer formed on the transparent film. More specifically, the birefringent layer exhibiting an optical uniaxiality (nx>nz, ny>nz) as described above further comes to exhibit an optical biaxiality (nx>ny>nz). It is preferable that an in-plane birefringence (Δn_{xyz}) and an in-plane retardation (Δnd) are controlled by this stretching or shrinking process.

First, the stretching process will be described. The method for stretching the birefringent layer is not particularly limited but can be, for example, a free-end longitudinal stretching of uniaxially stretching a laminate of the transparent film and the birefringent layer in a longitudinal direction, a fixed-end transverse stretching of uniaxially stretching the film in a width direction while the longitudinal direction of the film is fixed, a sequential or simultaneous biaxial stretching of stretching the film both in the longitudinal direction and the width direction, or the like.

The birefringent layer may be stretched, for example, by pulling both of the transparent film and the birefringent film together but preferably by stretching the transparent film alone for the following reason. In the case of stretching the transparent film alone, a resulting tension generated in the transparent film indirectly stretches the birefringent layer on the transparent film. Also, since a monolayer usually is stretched more uniformly than a laminate, uniformly stretching the transparent film alone as described above also allows the birefringent layer on the transparent film to be stretched uniformly.

The stretching condition is not particularly limited but can be determined suitably according to the kinds of forming materials for the transparent film and the birefringent layer, for example. For instance, the stretching magnification preferably is larger than 1× and not larger than 5×, more preferably is larger than 1× and not larger than 4× and particularly preferably is larger than 1× and not larger than 3×.

Now, the shrinking process will be described. In the case of performing the shrinking treatment, a shrinkable transparent film is used as the transparent film, for example. Then, after the process of forming the birefringent layer by hardening the coating film, the transparent film is shrunk, thereby shrinking the birefringent layer formed on the transparent film. This can change the birefringent layer into that having an optical biaxiality as described above.

The transparent film can be shrunk, for example, by subjecting the transparent film to a heating treatment, and this allows the birefringent layer to shrink accordingly. The condition for the heating treatment is not particularly limited but can be determined suitably according to the kinds of the material for the transparent film. For example, the heating temperature ranges from 25° C. to 300° C., preferably from 50° C. to 200° C. and particularly preferably from 60° C. to 180° C.

The shrinkability of the transparent film can be provided by subjecting the transparent film to a heating treatment in advance, for example. In order to make the transparent film shrinkable in one direction within its surface, it is preferable that the transparent film is pre-stretched in any one direction within its surface, for example. By this pre-stretching, a shrinking force is generated in a direction opposite to the stretching direction, so that the difference in shrinkage within the surface of the transparent film is utilized for providing the non-liquid crystal polymer in the birefringent layer with the difference in refractive index within the surface.

The thickness of the transparent film before being stretched is not particularly limited but ranges, for example, from 10 to 200 μm, preferably from 20 to 150 μm and more preferably from 30 to 100 μm. The stretching magnification is not particularly limited as long as the birefringent layer formed on the transparent film after being stretched exhibits an optical biaxiality (nx>ny>nz).

Other than the above, the birefringent layer also can be shrunk by, for example, forming a coating film on the transparent film, fixing these films to a metal frame and heating them.

The optical film of the present invention is not particularly limited as long as it includes the laminate obtained by forming the birefringent layer on the transparent film by the producing method described above. The laminate can be used alone, or it further can be combined with other optical members as necessary for various optical uses.

The optical film of the present invention can be, for example, a laminated polarizing plate further including a polarizer. The structure of the polarizing plate is not particularly limited, and the examples thereof are illustrated in FIGS. 1 and 2. FIGS. 1 and 2 are sectional views respectively showing the examples of the laminated polarizing plate of the present invention, with the same parts assigned with the same reference numerals. The polarizing plate of the present invention is not limited to the structure described below and may further include other optical members or the like.

A laminated polarizing plate 20 shown in FIG. 1 includes a laminate 1 of the transparent film and the birefringent layer described above, a polarizer 2 and two transparent protective layers 3. The transparent protective layers 3 are laminated on both surfaces of the polarizer 2, and the laminate 1 is further laminated on one of the transparent protective layers 3. As the laminate 1 is a laminate of the birefringent layer and the transparent film as mentioned above, either surface of the laminate 1 may face the transparent protective film 3. However, it is preferable that the polarizer is laminated on the birefringent layer of the laminate via the transparent protective layer.

The transparent protective layers may be laminated on both surfaces of the polarizer as shown in the figure or only on one surface thereof. Further, when they are laminated on both surfaces, the kinds of the transparent protective layers may be the same or different.

On the other hand, a laminated polarizing plate 30 shown in FIG. 2 has the above-described laminate 1, the polarizer 2 and the transparent protective layer 3. The laminate 1 is laminated on one surface of the polarizer 2, while the transparent protective layer 3 is laminated on the other surface of the polarizer 2.

As the laminate 1 is a laminate of the birefringent layer and the transparent film as described earlier, either surfaces thereof may face the polarizer. However, it is preferable that the polarizer 2 is arranged on the side of the transparent film of the laminate 1 for the following reason. With such a structure, the transparent film of the laminate 1 can be used also as the transparent protective layer for the polarizer. In other words, instead of laminating both surfaces of the polarizer with transparent protective layers, one surface of the polarizer is laminated with the transparent protective layer and the other surface thereof is laminated with the laminate such that the transparent film faces this surface. Accordingly, the transparent film also serves as the other transparent protective layer for the polarizer. Consequently, it is possible to obtain a still thinner polarizing plate.

The polarizer is not particularly limited but can be a film prepared by a conventionally known method of, for example, dyeing by allowing a film of various kinds to adsorb a dichroic material such as iodine or a dichroic dye, followed by cross-linking, stretching and drying. Especially, films transmitting linearly polarized light when natural light is made to enter those films are preferable, and films having excellent light transmittance and polarization degree are preferable. Examples of the film of various kinds in which the dichroic material is to be adsorbed include hydrophilic polymer films such as polyvinyl alcohol (PVA)-based films, partially-formalized PVA-based films, partially-saponified films based on ethylene-vinyl acetate copolymer and cellulose-based films. Other than the above, polyene aligned films such as dehydrated PVA and dehydrochlorinated polyvinyl chloride can be used, for example. Among them, the PVA-based film is preferable. In addition, the thickness of the polarizer generally ranges from 1 to 80 μm, though it is not limited to this.

The transparent protective layer is not particularly limited but can be a conventionally known transparent film. For example, transparent films having excellent transparency, mechanical strength, thermal stability, moisture shielding property and isotropism are preferable. Specific examples of materials for such a transparent protective layer can be similar to the materials for the above-described transparent film. It is preferable that the transparent protective layer is colorless. More specifically, a retardation value (Rth) of the film in its thickness direction as represented by the equation below preferably ranges from −90 nm to +75 nm, more preferably ranges from −80 nm to +60 nm, and particularly preferably ranges from −70 nm to +45 nm. When the retardation value is within the range of −90 nm to +75 nm, coloration (optical coloration) of the polarizing plate, which is caused by the protective film, can be solved sufficiently. In the equation below, nx, ny and nz are refractive indices of an X axis, a Y axis and a Z axis in the protective film, and d indicates the thickness of this film.
Rth=[{(nx+ny)/2}−nz]·d

The transparent protective layer further may have an optically compensating function. As such a transparent protective layer having the optically compensating function, it is possible to use, for example, a known layer used for preventing coloration caused by changes in a visible angle based on retardation in a liquid crystal cell or for widening a preferable viewing angle. Specific examples include various stretched films obtained by stretching the above-described transparent resins uniaxially or biaxially, an aligned film of a liquid crystal polymer or the like, and a laminate obtained by providing an aligned layer of a liquid crystal polymer on a transparent base. Among the above, the aligned film of a liquid crystal polymer is preferable because a wide viewing angle with excellent visibility can be achieved. Particularly preferable is an optically compensating retardation plate obtained by supporting an optically compensating layer with the above-mentioned triacetylcellulose film or the like, where the optically compensating layer is made of an incline-aligned layer of a discotic or nematic liquid crystal polymer. This optically compensating retardation plate can be a commercially available product, for example, “WV film” manufactured by Fuji Photo Film Co., Ltd. Alternatively, the optically compensating retardation plate can be prepared by laminating two or more layers of the retardation film and a film support of triacetylcellulose film or the like so as to control the optical characteristics such as retardation.

The thickness of the transparent protective layer is not particularly limited but can be determined suitably according to retardation or a protection strength, for example. In general, the thickness is not greater than 500 μm, preferably ranges from 5 to 300 μm, and more preferably ranges from 5 to 150 μm.

The transparent protective layer can be formed suitably by a conventionally known method such as a method of coating a polarizing film with the above-mentioned various transparent resins or a method of laminating the polarizing film with the transparent resin film, the optically compensating retardation plate or the like, or can be a commercially available product.

The above-described transparent protective layer may be further subjected to, for example, a hard coating treatment, an antireflection treatment, treatments for anti-sticking, diffusion and anti-glaring and the like. The hard coating treatment aims to prevent scratches on the surfaces of the polarizing plate, and is a treatment of, for example, providing a hardened coating film that is formed of a curable resin and has excellent hardness and smoothness onto a surface of the transparent protective film. The curable resin can be, for example, ultraviolet-curing resins of silicone base, urethane base, acrylic, and epoxy base. The treatment can be carried out by a conventionally known method. The anti-sticking treatment aims to prevent adjacent layers from sticking to each other. The antireflection treatment aims to prevent reflection of external light on the surface of the polarizing plate, and can be carried out by forming a known antireflection film or the like.

The anti-glare treatment aims to prevent reflection of external light on the polarizing plate surface from hindering visibility of light transmitted through the polarizing plate. The anti-glare treatment can be carried out, for example, by providing microscopic asperities on a surface of a transparent protective layer by a conventionally known method. Such microscopic asperities can be provided, for example, by roughening the surface by sand-blasting or embossing, or by blending transparent fine particles in the above-described transparent resin when forming the transparent protective layer.

The above-described transparent fine particles may be silica, alumina, titania, zirconia, stannic oxide, indium oxide, cadmium oxide, antimony oxide or the like. Other than the above, inorganic fine particles having an electrical conductivity or organic fine particles comprising, for example, crosslinked or uncrosslinked polymer particles can be used as well. The average particle diameter of the transparent fine particles ranges, for example, from 0.5 to 20 μm, though there is no specific limitation. In general, a blend ratio of the transparent fine particles preferably ranges from 2 to 70 parts by weight, and more preferably ranges from 5 to 50 parts by weight with respect to 100 parts by weight of the above-described transparent resin, though there is no specific limitation.

An anti-glare layer in which the transparent fine particles are blended can be used as the transparent protective layer itself or provided as a coating layer applied onto the transparent protective layer surface. Furthermore, the anti-glare layer also can function as a diffusion layer to diffuse light transmitted through the polarizing plate in order to widen the viewing angle (i.e., visually-compensating function).

The antireflection layer, the anti-sticking layer, the diffusion layer and the anti-glare layer mentioned above can be laminated on the polarizing plate, as a sheet of optical layers comprising these layers, separately from the transparent protective layer.

It is preferable that the optical film of the present invention further includes at least one of an adhesive layer and a pressure-sensitive adhesive layer. This makes it easier for the optical film of the present invention to adhere to the other members such as the other optical layers and a liquid crystal cell and also prevents the optical film of the present invention from peeling off. Accordingly, the adhesive layer and the pressure-sensitive adhesive layer are laminated preferably as an outermost layer of the optical film, and they may be laminated as one or both of the outermost layers of the optical film.

The material for the adhesive layer is not particularly limited but can be, for example, a polymer adhesive based on an acrylic substance, vinyl alcohol, silicone, polyester, polyurethane, polyether or the like or a rubber-based adhesive. It also may be possible to incorporate fine particles into these materials so as to form a layer showing light diffusion property. Among these materials, materials having excellent moisture absorption and heat resistance are preferable, for example. When the material with such properties is used in a liquid crystal display, for example, it is possible to provide a high-quality durable display apparatus that can prevent foaming or peeling caused by moisture absorption, degradation in the optical characteristics and warping of a liquid crystal cell caused by difference in thermal expansion coefficients and the like.

The method for laminating the constituent members (the polarizer and the transparent protective layer etc.) is not particularly limited but can be a conventionally known method. In general, a pressure-sensitive adhesive, an adhesive or the like similar to the above can be used. The kind thereof can be determined suitably depending on materials of the constituent members. The adhesive can be, for example, a polymer adhesive based on acrylic substances, vinyl alcohol, silicone, polyester, polyurethane or polyether, or a rubber-based adhesive. Alternatively, the adhesive can contain a water-soluble cross-linking agent of vinyl alcohol-based polymers, such as glutaraldehyde, melamine and oxalic acid. The pressure-sensitive adhesive and the adhesive mentioned above do not peel off easily even when being exposed to moisture or heat, for example, and have excellent light transmittance and polarization degree. More specifically, these pressure-sensitive adhesive and adhesive preferably are PVA-based adhesives when the polarizer is a PVA-based film, in light of stability of adhering treatment. These adhesive and pressure-sensitive adhesive may be applied to surfaces of the polarizer and the transparent protective layer, or a layer of a tape or a sheet formed of the adhesive or pressure-sensitive adhesive may be arranged on the surfaces thereof. Further, when these adhesive and pressure-sensitive adhesive are prepared as an aqueous solution, for example, other additives or a catalyst such as an acid catalyst may be blended as necessary. In the case of applying the adhesive, other additives or a catalyst such as an acid catalyst further may be blended in the aqueous solution of the adhesive. The thickness of the adhesive layer is not particularly limited but may be, for example, 1 to 500 nm, preferably 10 to 300 nm, and more preferably 20 to 100 nm. It is possible to adopt a conventionally known method of using an adhesive etc. such as an acrylic polymer or a vinyl alcohol-based polymer without any particular limitations. Further, because it is possible to form a polarizing plate that does not peel off easily even when being exposed to moisture or heat and has excellent light transmittance and polarization degree, the adhesive containing a water-soluble cross-linking agent of PVA-based polymers, such as glutaraldehyde, melamine and oxalic acid is preferable. These adhesives can be used, for example, by applying its aqueous solution to the surface of each constituent member mentioned above, followed by drying. In the above aqueous solution, other additives or a catalyst such as an acid catalyst may be blended as necessary. Among these, the adhesive preferably is a PVA-based adhesive because an excellent adhesiveness to a PVA film can be achieved.

Furthermore, the optical film according to the present invention also can be used in combination with conventionally known optical members such as retardation plates, diffusion control films and brightness enhancement films of various types other than the above-described polarizer. Examples of the above-mentioned retardation plates include a film obtained by stretching a polymer film uniaxially or biaxially, a film treated with a Z-axis alignment and a coating film of a liquid crystal polymer. The above-mentioned diffusion control films can be, for example, films utilizing diffusion, scattering and refraction and used for controlling a viewing angle, controlling glare or scattering light associated with resolution. The above-mentioned brightness enhancement films can be, for example, brightness enhancement films using a selective reflection of a cholesteric liquid crystal and a quarter wavelength plate (a λ/4 plate) or scattering films utilizing an anisotropic scattering owing to a polarization direction. The optical films also can be combined with a wire grid polarizer.

At the time of an actual use, the laminated polarizing plate of the present invention may include other optical layers in addition to the optical film of the present invention. Examples of such optical layers include various conventionally known optical layers used for forming a liquid crystal display, for example, a polarizing plate, a reflector, a semitransparent reflector and a brightness enhancement film as described below. These optical layers may be of one kind or two or more kinds. Also, one layer or two or more layers of these optical layers may be provided. The laminated polarizing plate further including such an optical layer preferably is used as, for example, an integral polarizing plate having an optical compensating function and is used suitably in various image display apparatuses, for example, placed on the surface of a liquid crystal cell.

The above-noted integral polarizing plates will be described below.

First, an example of the reflective polarizing plate or the semitransparent reflective polarizing plate will be described. The reflector is provided further to a laminated polarizing plate of the present invention in order to form the reflective polarizing plate, and the semitransparent reflector is provided further to a laminated polarizing plate of the present invention in order to form the semitransparent reflective polarizing plate.

In general, such a reflective polarizing plate is arranged on a backside of a liquid crystal cell in order to make a liquid crystal display (a reflective liquid crystal display) reflect incident light from a visible side (display side). The reflective polarizing plate has some advantages in that, for example, assembling of light sources such as backlight can be omitted, and the liquid crystal display can be made thinner.

The reflective polarizing plate can be formed in any known manner such as forming a reflector of metal or the like on one surface of the polarizing plate having the elastic modulus. For example, a transparent protective layer of the polarizing plate is prepared by matting one surface (exposed surface) if required. On this surface, a metal foil comprising a reflective metal such as aluminum or a deposition film is applied to form a reflective polarizing plate.

An additional example of a reflective polarizing plate comprises the above-mentioned transparent protective layer having a surface of a microscopic asperity due to fine particles contained in various transparent resins, and also a reflector corresponding to the microscopic asperity. The reflector having a microscopic asperity surface diffuses incident light by irregular reflection so that directivity and glare can be prevented and irregularity in color tones can be controlled. This reflector can be formed by disposing a metal foil or a metal deposition film on a microscopic asperity surface of the transparent protective layer in any conventionally known methods including deposition such as vacuum deposition, and plating such as ion plating and sputtering.

Alternatively, as the reflector, it may be possible to use a reflecting sheet formed by providing a reflecting layer onto a proper film similar to the transparent protective film. Since the reflecting layer of the reflector typically is made of a metal, it is preferable in use of the reflector that the reflecting surface of the reflecting layer is coated with the film, a polarizing plate or the like in order to prevent the reflection rate from lowering due to oxidation. As a result, the initial reflection rate is maintained for a long period, and a separate transparent protective layer can be omitted.

On the other hand, the semitransparent reflective polarizing plate is provided by replacing the reflection plate in the above-mentioned reflective polarizing plate by a semitransparent reflector, and it is exemplified by a half mirror that reflects and transmits light at the reflecting layer.

In general, such a semitransparent reflective polarizing plate is arranged on a backside of a liquid crystal cell. In a liquid crystal display comprising the semitransparent reflective polarizing plate, incident light from the visible side (display side) is reflected to display an image when the liquid crystal display is used in a relatively bright atmosphere, while in a relatively dark atmosphere, an image is displayed by using a built-in light source such as a backlight in the backside of the semitransparent reflective polarizing plate. In other words, the semitransparent reflective polarizing plate can be used to form a liquid crystal display that can save energy for a light source such as a backlight under a bright atmosphere, and on the other hand, can be used with a built-in light source under a relatively dark atmosphere.

Now, an example of a polarizing plate obtained by further laminating a brightness enhancement film on the laminated polarizing plate of the present invention will be described.

The brightness enhancement film is not particularly limited but can be a film having a property of transmitting linearly polarized light with a predetermined polarization axis and reflecting other light, for example, a dielectric multilayer thin film or a multilayer laminate of thin films with different refractive index anisotropies. Such a brightness enhancement film is, for example, trade name “D-BEF” manufactured by 3M Corporation. It also is possible to use a cholesteric liquid crystal layer, especially an aligned film of a cholesteric liquid crystal polymer, and this aligned liquid crystal layer supported on a film base. These films exhibit a property of reflecting one of right and left circularly polarized lights and transmitting the other light and are, for example, trade name “PCF350” manufactured by Nitto Denko Corporation or trade name “Transmax” manufactured by Merck Ltd.

The above-described polarizing plates of various kinds according to the present invention may be an optical member obtained by, for example, layering two or more optical layers in addition to the laminated polarizing plate of the present invention.

Such an optical member including two or more laminated optical layers of course can be formed by laminating each layer sequentially in each producing process of a liquid crystal display, for example. However, the use of an optical member that has been laminated in advance has an advantage in that excellent quality stability and assembling operability are achieved, leading to an improvement in the efficiency in producing a liquid crystal display. Incidentally, similarly to the above, various adhesive means such as a pressure-sensitive adhesive layer can be used for the lamination.

Moreover, it is preferable that the above-described various polarizing plates further have a pressure-sensitive adhesive layer or an adhesive layer, which allows easier lamination onto the other members such as a liquid crystal cell. These adhesive layers can be arranged on one surface or both surfaces of the polarizing plate. The material for the pressure-sensitive adhesive layer is not particularly limited but can be a conventionally known material such as acrylic polymers. In particular, the pressure-sensitive adhesive layer having a low moisture absorption coefficient and an excellent heat resistance is preferable from the aspects of prevention of foaming or peeling caused by moisture absorption, prevention of degradation in the optical properties and warping of a liquid crystal cell caused by difference in thermal expansion coefficients and formation of a liquid crystal display with high quality and excellent durability. It also may be possible to incorporate fine particles so as to form the pressure-sensitive adhesive layer showing light diffusion property. The pressure-sensitive adhesive layer can be formed on the surface of the polarizing plate by, for example, applying a solution or a melt of various pressure-sensitive adhesive materials to a predetermined surface of the polarizing plate by an expansion method such as flow-expansion or coating, or forming a pressure-sensitive adhesive layer on a separator, which will be described later, in the same manner and transferring it to a predetermined surface of the polarizing plate. Such a layer can be formed on either surface of the polarizing plate. For example, it can be formed on an exposed surface of the retardation plate of the polarizing plate.

In the case where a surface of the pressure-sensitive adhesive layer provided in the polarizing plate is exposed as mentioned above, it is preferable to cover the surface with a separator for the purpose of preventing the pressure-sensitive adhesive layer from being contaminated until it is put to use. This separator can be formed by, for example, providing a suitable film such as the above-mentioned transparent protective film with at least one release coat such as a silicone-based release agent, a long-chain alkyl-based release agent, a fluorocarbon release agent or molybdenum sulfide, as necessary.

The pressure-sensitive adhesive layer can be a monolayer or a laminate, for example. The laminate can be, for example, a combination of monolayers having different compositions or kinds. Further, when arranged on both surfaces of the polarizing plate, these pressure-sensitive adhesive layers may be the same or different in composition or kind.

The thickness of the pressure-sensitive adhesive layer can be determined suitably, for example, according to the structure of the polarizing plate and generally ranges from 1 to 500 μm.

It is preferable that the pressure-sensitive adhesive layer is formed of a pressure-sensitive adhesive exhibiting an excellent optical transparency, a moderate wettability and pressure-sensitive adhesive properties such as cohesiveness and adhesiveness. Specific examples thereof include pressure-sensitive adhesives prepared based on suitable polymers such as an acrylic polymer, a silicone-based polymer, polyester, polyurethane, polyether and synthetic rubber.

The adhesive properties of the pressure-sensitive adhesive layer can be controlled suitably by a conventionally known method. For example, the degree of cross-linkage and the molecular weight are adjusted on the basis of a composition or molecular weight of the base polymer for forming the pressure-sensitive adhesive layer, a cross-linking method, a ratio of the contained cross-linkable functional group, and a ratio of the blended cross-linking agent.

The individual layers such as a polarizing film, a transparent protective layer, an optical layer and a pressure-sensitive adhesive layer constituting the optical film, the polarizing plate and various optical members (various polarizing plates obtained by laminating optical layers) according to the present invention as described above may be treated suitably with an UV absorber such as salicylate ester compounds, benzophenolic compounds, benzotriazole compounds, cyanoacrylate compounds or nickel complex salt-based compounds, thus providing an UV absorbing capability.

As described above, the optical film and the polarizing plate of the present invention preferably is used for forming various apparatuses such as a liquid crystal display. For example, the optical film and the polarizing plate of the present invention can be arranged on one surface or both surfaces of the liquid crystal cell so as to form a liquid crystal panel and can be used in a reflective-type, semitransparent-type or transparent and reflective type liquid crystal display.

The kind of the liquid crystal cell forming the liquid crystal display is freely selectable and can be any type of liquid crystal cells such as an active-matrix driving type represented by a thin-film transistor type, or a simple-matrix driving type represented by a twisted nematic type or a super twisted nematic type. The optical film of the present invention has an excellent optical compensation function for, in particular, a TN (twisted nematic) cell, a VA cell or an OCB cell among the above and thus is very useful in a liquid crystal display including these liquid crystal cells.

The liquid crystal cell typically has a structure in which liquid crystal is injected into a space between opposing liquid crystal cell substrates. The liquid crystal cell substrates can be made of glass, plastics or the like without any specific limitations. Materials for the plastic substrates can be selected from conventionally known materials without any specific limitations.

When the polarizing plates or the optical members are arranged on both surfaces of a liquid crystal cell, they can be the same or different in kind. Moreover, for forming a liquid crystal display, one layer or two or more layers of appropriate parts such as a prism array sheet, a lens array sheet, an optical diffuser and a backlight can be arranged at appropriate positions.

The liquid crystal display according to the present invention is not limited specifically as long as the liquid crystal panel of the present invention is used as its liquid crystal panel. In the case of providing a light source, although there is no specific limitation on this light source, a flat surface light source emitting polarized light is preferable, for example, because light energy can be utilized effectively.

FIG. 3 is a sectional view showing an example of the liquid crystal panel according to the present invention. As shown in the figure, a liquid crystal panel 40 has a liquid crystal cell 21, a laminate 1 of a transparent film and a birefringent layer, a polarizer 2 and a transparent protective layer 3. One surface of the laminate 1 is provided with the liquid crystal cell 21, while the other surface of the laminate 1 is laminated with the polarizer 2 and the transparent protective layer 3 in this order. The liquid crystal cell 21 has a structure in which liquid crystal is retained between two liquid crystal cell substrates (not shown). In the laminate 1, the birefringent layer and the transparent film are layered as described earlier, with the birefringent layer side facing the liquid crystal cell 21 and the transparent film side facing the polarizer 2.

In the liquid crystal display according to the present invention, it also is possible to further dispose a diffusion plate, an anti-glare layer, an antireflection film, a protective layer or plate, on the optical film (the polarizing plate) on the viewing side. Alternatively, a retardation plate for compensation or the like can be disposed suitably between a liquid crystal cell and the polarizing plate in the liquid crystal panel.

Incidentally, the optical film and the polarizing plate according to the present invention are not limited to a use in the liquid crystal display described above but also can be used in self-light-emitting displays such as an organic electroluminescence (EL) display, a PDP and an FED. When used in self-light-emitting flat displays, the birefringent optical film of the present invention can be utilized as an antireflection filter because it can obtain circularly polarized light by setting its in-plane retardation value And to λ/4.

The following is a description of an electroluminescence (EL) display including the optical film of the present invention. The EL display according to the present invention has the optical film of the present invention and may be either an organic EL display or an inorganic EL display.

In recent years, for EL displays, it has been suggested to use an optical film such as a polarizer or a polarizing plate together with a λ/4 plate for preventing reflection from an electrode in a black state. The polarizer and the optical film of the present invention are very useful particularly when any of linearly polarized light, circularly polarized light and elliptically polarized light is emitted from the EL layer, or when obliquely emitted light is polarized partially even if natural light is emitted in the front direction.

The following description is directed to a typical organic EL display. In general, an organic EL display has a ruminant (organic EL ruminant) that is prepared by laminating a transparent electrode, an organic ruminant layer and a metal electrode in a certain order on a transparent substrate. Here, the organic luminant layer is a laminate of various organic thin films. Known examples thereof include a laminate of a hole injection layer made of triphenylamine derivative or the like and a ruminant layer made of a phosphorous organic solid such as anthracene; a laminate of the ruminant layer and an electron injection layer made of perylene derivative or the like; or a laminate of the hole injection layer, the luminant layer and the electron injection layer.

In general, the organic EL display emits light on the following principle: a voltage is applied to the anode and the cathode so as to inject holes and electrons into the organic ruminant layer, energy generated by the re-bonding of these holes and electrons excites the phosphor, and the excited phosphor emits light when it returns to the basis state. The mechanism of the re-bonding during the process is similar to that of an ordinary diode. This implies that current and the light emitting intensity exhibit a considerable nonlinearity accompanied with a rectification with respect to the applied voltage.

It is necessary for the organic EL display that at least one of the electrodes is transparent so as to obtain luminescence at the organic ruminant layer. In general, a transparent electrode of a transparent conductive material such as indium tin oxide (ITO) is used for the anode. Use of substances having small work function for the cathode is important for facilitating the electron injection and thereby raising luminous efficiency, and in general, metal electrodes such as Mg—Ag, and Al—Li may be used.

In an organic EL display configured as described above, it is preferable that the organic luminant layer is made of a film that is extremely thin such as about 10 nm. Therefore, the organic luminant layer can transmit substantially whole light as the transparent electrode does. As a result, when the layer does not illuminate, a light beam entering from the surface of the transparent substrate and passing through the transparent electrode and the organic luminant layer before being reflected at the metal electrode comes out again to the surface of the transparent substrate. Thereby, the display surface of the organic EL display looks like a mirror when viewed from the outside.

The organic EL display according to the present invention includes, for example, the organic EL luminant formed by providing a transparent electrode on the surface of the organic luminant layer and a metal electrode on the backside of the organic luminant layer, and preferably, an optical film (such as a polarizing plate) according to the present invention is arranged on the surface of the transparent electrode. More preferably, a λ/4 plate is arranged between the polarizing plate and an EL device. By arranging the optical film of the present invention as described above, the organic EL display has an effect of suppressing external reflection and improving visibility. It is also preferable that a retardation plate further is arranged between the transparent electrode and the optical film.

The retardation plate and the optical film (such as the polarizing plate etc.) function to polarize light which enters from outside and is reflected by the metal electrode, for example, and thus the polarization has an effect that the mirror of the metal electrode cannot be viewed from the outside. Particularly, the mirror of the metal electrode can be blocked completely by forming the retardation plate with a quarter wavelength plate and adjusting an angle formed by the polarization directions of the polarizing plate and the retardation plate to be π/4. That is, the polarizing plate transmits only the linearly polarized light component among the external light entering the organic EL display. In general, the linearly polarized light is changed into elliptically polarized light by the retardation plate. However, when the retardation plate is a quarter wavelength plate and when the above-noted angle is π/4, the light is changed into circularly polarized light.

For example, this circularly polarized light passes through the transparent substrate, the transparent electrode, and the organic thin film. After being reflected by the metal electrode, the light passes again through the organic thin film, the transparent electrode and the transparent substrate, and turns into linearly polarized light at the retardation plate. Moreover, since the linearly polarized light crosses the polarization direction of the polarizing plate at a right angle, it cannot pass through the polarizing plate. As a result, the mirror of the metal electrode can be blocked completely as mentioned earlier.

### EXAMPLES

The following is a more specific description of the present invention by way of Examples and Comparative Examples, though the present invention is by no means limited thereto. Incidentally, the characteristics of the optical film were evaluated as follows.

(Determination of Structural Formula)

A sample was prepared by dissolving 50 mg of polyimide sample into 0.6 mL deuterated dimethyl sulfoxide (DMSO) and underwent ¹H-NMR measurement at 400 MHz using trade name LA400 (manufactured by JEOL. Ltd.).

(Measurement of Molecular Weight)

Each polyimide sample was dissolved into DMF (N,N-dimethylformamide) so as to obtain a 0.1 wt % solution. After this solution was filtered using a 0.45-μm membrane filter, the molecular weight was measured in terms of polyethylene oxide standard using trade name HLC-8120GPC (manufactured by TOSOH CORPORATION).

(Measurement of Refractive Index)

The refractive index of the obtained optical film was measured using an Abbe refractometer.

(Measurement of Retardation, Birefringence and Transmittance)

The value at a wavelength of 590 nm was measured using an automatic birefringence analyzer (trade name KOBRA-21ADH; manufactured by Oji Scientific Instruments). With respect to the retardation (Rth) in the thickness direction, the value was measured for incident light from a direction inclined by 40° from a normal line of the optical film.

(Measurement of Film Thickness)

The thickness of the birefringent layer was measured using an instant multiple photometry system (trade name MCPD-2000; manufactured by Otsuka Electronics Co., Ltd.).

### Example 1

Using 2,2′-bis(3,4-dicarboxyphenyl)hexafluoropropane acid dianhydride (6FDA) and 2,2′-bis(trifluoromethyl)-4,4′-diaminobiphenyl (PFMB), polyimide (Mw=177,000) formed of the repeating unit represented by the formula (1) was synthesized. This polyimide was dissolved in MIBK, thus preparing a 14 wt % polyimide solution. After the polyimide solution was applied to a transparent film (having a thickness of about 55 μm), which will be described below, it was dried at 100° C. for 5 minutes and then dried at 150° C. for 20 minutes. In this manner, a polyimide layer (a birefringent layer) (having a thickness of 5.0 μm) was formed on the above-mentioned transparent film. The polyimide layer in the resultant optical film had a refractive index of 1.55, a birefringence (Δn_{xyz}) in the thickness direction of 0.041 and a transmittance of 92.1%.

The above-mentioned transparent film was produced as follows. First, 65 parts by weight of a glutarimide copolymer of N-methylglutarimide and methyl methacrylate (the N-methylglutarimide content: 75 wt %, the acid content: not greater than 0.01 milliequivalent/g, the glass transition temperature: 147° C.) and 35 parts by weight of a copolymer of acrylonitrile and styrene (the acrylonitrile content: 28 wt %, the styrene content: 72 wt %) were melted and mixed. The resultant resin composition was supplied to a T-die melt extruder, thus obtaining a film with a thickness of 135 μm. This film was stretched to 1.7 times its original length in an MD direction at 160° C. and further stretched to 1.8 times its original length in a TD direction. The resultant biaxially-stretched transparent film had a thickness of 55 μm, an in-plane retardation (Δnd) of 1 nm and a retardation (Rth) in the thickness direction of 3 nm.

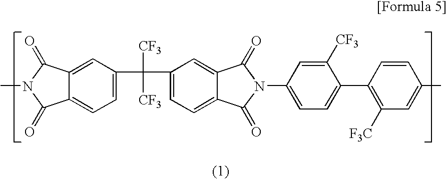

### Example 2

As described later, using 2,2′-dichloro-4,4′,5,5′-biphenyl tetracarboxylic acid dianhydride (DCBPDA) and 2,2′-bis(trifluoromethyl)-4,4′-diaminobiphenyl (PFMB), polyimide (Mw=82,500) formed of the repeating unit represented by the formula (2) below was synthesized. Except for using this polyimide, a polyimide layer (a birefringent layer) was formed on the transparent film similarly to Example 1 described above, thereby producing an optical film. The polyimide layer in the resultant optical film had a refractive index of 1.57, a birefringence (Δn_{xyz}) in the thickness direction of 0.075 and a transmittance of 90.4%.

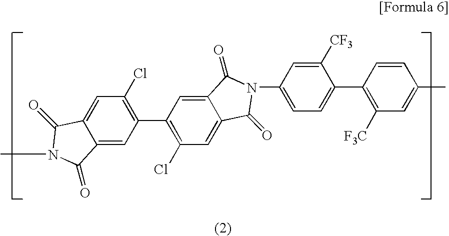

The above-noted DCBPDA was synthesized as follows. First, 27.2 g (0.68 mol) NaOH was dissolved in 400 ml water, and 5.0 g (0.17 mol) 3,3′,4,4′-biphenyl tetracarboxylic acid dianhydride (BPDA) was dissolved in this NaOH aqueous solution. This solution was heated up to 100° C., and a chlorine gas was injected into the solution, whereby 5 minutes after the injection, white precipitate was formed. After the white precipitate was dissolved again by adding an NaOH aqueous solution (20.0 g NaOH was dissolved in 50 ml water) gradually thereto, a chlorine gas further was injected, so that precipitate was formed again. After allowing a reaction to proceed until no precipitate was formed anymore (about 45 minutes), the solution was cooled down to room temperature, and then the formed precipitate was filtered. This precipitate was washed with 30 ml water and dried, thus obtaining 64.4 g DCBTC-Na (2,2′-dichloro-4,4′,5,5′-biphenyl tetracarboxylic acid, sodium salt). Subsequently, the dried 60.0 g DCBTC-Na was suspended in an HCl aqueous solution (60 ml HCl and 200 ml water) and stirred at 90° C. for 3 hours. The reaction solution was cooled down to room temperature, and white precipitate was filtered, thus obtaining 45.0 g DCBPTC (2,2′-dichloro-4,4′,5,5′-biphenyl tetracarboxylic acid). The DCBPTC further was dried under reduced pressure (3 to 5 mmHg) at 260° C. to 280° C. to allow dehydration, so that DCBPDA (2,2′-dichloro-4,4′,5,5′-biphenyl tetracarboxylic acid dianhydride) was obtained. The DCBPDA was purified by recrystallization with toluene and dioxane. The result of analyzing the obtained DCBPDA is shown below.

¹H-NMR (DMSO-d₆): σ8.28 (s, 2H, aromatic), σ8.53 (s, 2H, aromatic)

The polyimide formed of the repeating unit of the formula (2) above was synthesized as follows. After PFMB (1.7 mmol) was dissolved completely in m-cresol, DCBPDA (1.7 mmol) and a suitable amount of m-cresol were added thereto (so that the concentration of the solution was 10 wt % with respect to the solids) and stirred under a nitrogen atmosphere for 3 hours. Then, after 5 drops of isoquinoline were added into this solution, the solution was stirred while heating at about 200° C. At this time, water generated by an imidization reaction was distilled together with 1 to 2 ml m-cresol. Thereafter, the solution was cooled down to room temperature and diluted to 5 wt % by adding m-cresol further. This diluted solution was dropped into vigorously-stirred volumetrically 5 times as much methanol, thereby forming a fibrous solid substance. This fibrous solid substance was collected by filtration, so that polyimide was obtained. By repeating twice an operation of immersing this polyimide in highly-pure methanol again and filtering it, desired polyimide was separated from m-cresol, isoquinoline and low-molecular-weight polyimide. Finally, the filtered polyimide was dried at 150° C. to 200° C. for 24 hours, thereby removing remaining solvent. The yield of the obtained polyimide was 91% to 95%.

### Example 3

Except for using a TAC film with a thickness of about 80 μm (trade name UZ-TAC; manufactured by Fuji Photo Film Co., Ltd.) instead of the transparent film, an optical film was produced similarly to Example 1 described above.

### Example 4

Except for using a TAC film with a thickness of about 80 μm (trade name UZ-TAC; manufactured by Fuji Photo Film Co., Ltd.) instead of the transparent film, an optical film was produced similarly to Example 2 described above.

### Comparative Example 1

Except for using ethyl acetate instead of MIBK, an optical film was produced similarly to Example 1 described above. Incidentally, since the obtained optical film had poor external appearance as described later, various optical characteristics thereof could not be measured. Thus, a polyimide layer was formed on a glass plate similarly to the above, and the optical characteristics of this polyimide layer were measured.

### Comparative Example 2

Except for using cyclopentanone instead of MIBK, an optical film was produced similarly to Example 1 described above. Incidentally, since the obtained optical film had poor external appearance as described later, various optical characteristics thereof could not be measured. Thus, a polyimide layer was formed on a glass plate similarly to the above, and the optical characteristics of this polyimide layer were measured.

### Comparative Example 3

Except for using ethyl acetate instead of MIBK, an optical film was produced similarly to Example 2 described above. Incidentally, since the obtained optical film had poor external appearance as described later, various optical characteristics thereof could not be measured. Thus, a polyimide layer was formed on a glass plate similarly to the above, and the optical characteristics of this polyimide layer were measured.

### Comparative Example 4

Except for using cyclopentanone instead of MIBK, an optical film was produced similarly to Example 2 described above. Incidentally, since the obtained optical film had poor external appearance as described later, various optical characteristics thereof could not be measured. Thus, a polyimide layer was formed on a glass plate similarly to the above, and the optical characteristics of this polyimide layer were measured.

### Comparative Example 5

Using 2,2′-bis(3,4-dicarboxyphenyl)hexafluoropropane acid dianhydride (6FDA) and 2,2′-dimethyl-4,4′-diaminobiphenyl (DMB), polyimide (Mw=59,900) formed of the repeating structural unit represented by the formula below was synthesized. This polyimide was added to the solvent similarly to Example 1 but could not be dissolved in MIBK.

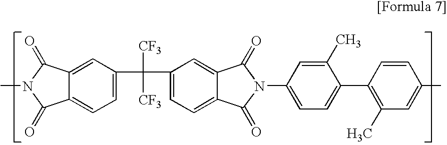

Then, except for dissolving the above-noted polyimide into cyclopentanone instead of MIBK, an optical film was produced similarly to Example 1 described above. Incidentally, since the obtained optical film had poor external appearance as described later, various optical characteristics thereof could not be measured. Thus, a polyimide layer was formed on a glass plate similarly to the above. The polyimide layer had a refractive index of 1.56, a birefringence (Δn_{xyz}) in the thickness direction of 0.028 and a transmittance of 87.2%.

### Comparative Example 6

Using acid dianhydride (2,2′-bis(4-(3,4-dicarboxy)phenyl)propane; BisADA) and 2,2′-bis(trifluoromethyl)-4,4′-diaminobiphenyl (PFMB), polyimide (Mw=51,800) formed of the repeating unit represented by the formula below was synthesized. This polyimide was added to the solvent similarly to Example 1 but could not be dissolved in MIBK.

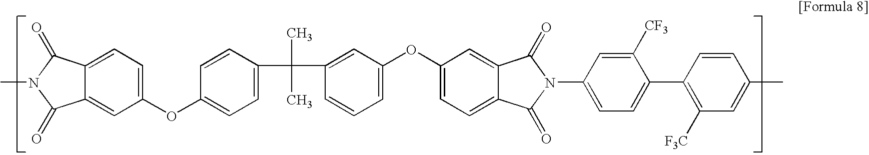

Then, except for dissolving the above-noted polyimide into cyclopentanone instead of MIBK, an optical film was produced similarly to Example 1 described above. Incidentally, since the obtained optical film had poor external appearance as described later, various optical characteristics thereof could not be measured. Thus, a polyimide layer was formed on a glass plate similarly to the above. The polyimide layer had a refractive index of 1.55, a birefringence (Δn_{xyz}) in the thickness direction of 0.022 and a transmittance of 88.5%.

### Comparative Example 7

Using acid dianhydride (3,3′,4,4′-biphenyl tetracarboxylic acid dianhydride; BPDA) and p-diaminobenzene (PDA), a polyamic acid formed of the repeating structural unit represented by the formula below was synthesized. Instead of polyimide, this polyamic acid was added to the solvent similarly to Example 1 but could not be dissolved in MIBK.

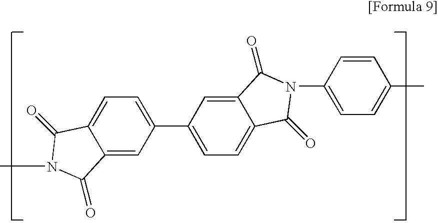

Then, except for dissolving the polyamic acid instead of the above-noted polyimide into N-dimethylacetamide instead of MIBK, an optical film was produced similarly to Example 1 described above. Incidentally, since the obtained optical film had poor external appearance as described later, various optical characteristics thereof could not be measured. Thus, a polyamic acid layer was formed on a glass plate similarly to the above. The polyamic acid layer had a refractive index of 1.71, a birefringence (Δn) in the thickness direction of 0.166 and a transmittance of 85.9%.

Table 1 below shows the optical characteristics of the optical films of Examples 1 to 4 and Comparative Examples 1 to 7 described above. Further, FIGS. 4 to 6 show photographs showing external appearances of these optical films. FIG. 4 is a photograph showing the external appearance of the optical film according to Example 1, and other Examples 2 to 4 also showed similar results (not shown). FIG. 5 is a photograph showing the external appearance of the optical film according to Comparative Example 1, and Comparative Example 3 also showed a similar result (now shown). FIG. 6 is a photograph showing the external appearance of the optical film according to Comparative Example 2, and other Comparative Examples 4 to 7 also showed similar results (not shown). In FIGS. 4 to 6, the polyimide solution was applied to a 10-cm wide central portion. Furthermore, the obtained optical films were subjected to a stretching treatment, thus measuring the thickness in the case where the optical film achieved a retardation (Rth) in its thickness direction of 200 nm and the thickness in the case where it achieved a retardation (Rth) in its thickness direction of 400 nm. Table 1 shows these results as well. Incidentally, the retardation (Rth) in the thickness direction of 200 nm is a retardation value preferable for compensating for a VA-mode liquid crystal cell, and that (Rth) of 400 nm is a retardation value preferable for compensating for an OCB-mode liquid crystal cell.

TABLE 1

| | | | | | Birefringent | External | | |
|---|---|---|---|---|---|---|---|---|
| | | | Birefringent | Birefringent | layer | appearance | Rth 200 nm | Rth 400 nm |
| | | | layer thickness | layer | transmittance | of optical | thickness | thickness |
| | Kind of polymer | Solvent | (μm) | Δn_{xyz} | (%) | film | (μm) | (μm) |
| Ex. 1 | 6FDA/PFMB | MIBK | 5.0 | 0.041 | 92.1 | Good | 4.9 | 10.7 |
| Ex. 2 | DCBPDA/PFMB | MIBK | 5.3 | 0.075 | 90.4 | Good | 2.7 | 5.3 |
| Ex. 3 | 6FDA/PFMB | MIBK | 5.0 | 0.041 | 92.1 | Good | 4.9 | 10.7 |
| Ex. 4 | DCBPDA/PFMB | MIBK | 5.3 | 0.075 | 90.4 | Good | 2.7 | 5.3 |
| Comp. | 6FDA/PFMB | Ethyl acetate | 5.0 | −(0.041) | −(92.1) | Poor | −(4.9) | −(10.7) |
| Ex. 1 | | | | | | | | |
| Comp. | 6FDA/PFMB | Cyclopentanone | 5.0 | −(0.041) | −(92.1) | Poor | −(4.9) | −(10.7) |
| Ex. 2 | | | | | | | | |
| Comp. | DCBPDA/PFMB | Ethyl acetate | 5.3 | −(0.075) | −(90.4) | Poor | −(2.7) | −(5.3) |
| Ex. 3 | | | | | | | | |
| Comp. | DCBPDA/PFMB | Cyclopentanone | 5.3 | −(0.075) | −(90.4) | Poor | −(2.7) | −(5.9) |
| Ex. 4 | | | | | | | | |
| Comp. | 6FDA/DMB | Cyclopentanone | 4.9 | −(0.028) | −(87.2) | Poor | −(7.1) | −(17.1) |
| Ex. 5 | | | | | | | | |
| Comp. | BisADA/PFMB | Cyclopentanone | 4.9 | −(0.022) | −(88.5) | Poor | −(9.1) | −(21.8) |
| Ex. 6 | | | | | | | | |
| Comp. | BPDA/PDA | N-dimethyl | 5.1 | −(0.166) | −(85.9) | Poor | −(1.2) | −(2.4) |
| Ex. 7 | | acetamide | | | | | | |

As shown in FIGS. 5 and 6 mentioned above, the portion where the polyimide solution was applied became cloudy in Comparative Examples 1 and 3, and the transparent film in the portion where the polyimide solution was applied cracked and became wrinkled in Comparative Examples 2, 4 to 7, so that they were found to be impracticable for optical uses. In contrast, as shown in FIG. 4, the optical films according to Examples 1 to 4 were free from clouds and wrinkles and had very good external appearance. It is clear that these films show excellent characteristics also in optical uses.

In particular, Comparative Examples 1 and 2 used the same polyimide as that in Example 1, and Comparative Examples 3 and 4 used the same polyimide as that in Example 2. However, unlike Examples 1 and 2, ethyl acetate or cyclopentanone that had a higher solvency than MIBK was used as the solvent instead of MIBK, causing the obtained optical films to have a problem in external appearance as shown in FIGS. 5 and 6. This also shows that the use of MIBK as the solvent achieves an excellent external appearance. Further, although the polyimides in Comparative Examples 5 and 6 had a birefringence in the thickness direction (0.028, 0.022) lower than those in Examples 1 and 2, they could not be dissolved in MIBK. This showed that, even if polyimide had a birefringence in the thickness direction of smaller than 0.03, it was not always soluble in MIBK and that change in the solvent caused a problem in external appearance similar to the conventional case. In the case where a birefringent layer was formed on the base, Comparative Examples 5 and 6 had a problem in external appearance, so that it was not possible to measure various optical characteristics. Even in the case where the birefringent layer alone was formed on a glass plate separately, since the birefringence in the thickness direction was smaller than 0.03, considerable thickness would be necessary for obtaining a sufficient retardation in the thickness direction (for example, Rth of 200 nm, Rth of 400 nm), leading to a larger thickness. Moreover, Comparative Example 7 had a birefringence in the thickness direction (Δn=0.166) higher than those of the polyimides in Examples 1 and 2 but could not be dissolved in MIBK. This shows that polyimide is not always soluble in MIBK even when it has a large birefringence in the thickness direction.

### Reference Example 1

Similarly to Example 2, using 2,2′-dichloro-4,4′,5,5′-biphenyl tetracarboxylic acid dianhydride (DCBPDA) and 2,2′-bis(trifluoromethyl)-4,4′-diaminobiphenyl (PFMB), polyimides formed of the repeating unit represented by the formula (2) below with different molecular weights were synthesized.

Then, the obtained polyimides were each used to form a polyimide layer (with a thickness of 5 μm) on a transparent film similarly to Example 1, and the birefringence (Δn_{xyz}) in the thickness direction of each layer was measured. The result shows that, as shown in Table 2 below, the birefringence in the thickness direction can be set larger with an increase in the molecular weight.

TABLE 2

| Molecular weight of polyimide | Δn_{xyz} |
|---|---|
| 15,100 | 0.061 |
| 32,200 | 0.067 |
| 67,400 | 0.070 |
| 80,100 | 0.072 |
| 94,200 | 0.077 |
| 131,000 | 0.084 |

### INDUSTRIAL APPLICABILITY

As described above, by using a solution obtained by dissolving a birefringent material containing a non-liquid crystal polymer that has a birefringence (Δn_{xyz}) in the thickness direction represented by the equation below of at least 0.03 and is soluble in the methyl isobutyl ketone into MIBK, it is possible to prevent coloration of the birefringent layer and cracks in the transparent film so as to obtain an optical film with an excellent external appearance even in the case where the birefringent layer is formed on the transparent film. Thus, if the optical film obtained by the producing method of the present invention is mounted on various image display apparatuses, excellent display characteristics can be achieved.

1. A method for producing an optical film comprising a birefringent layer and a transparent film, the method comprising:
applying onto the transparent film a solution obtained by dissolving a birefringent material into a solvent; and
forming the birefringent layer by hardening a formed coating film;
wherein the solvent is methyl isobutyl ketone, and
the birefringent material comprises a non-liquid crystal polymer that has a birefringence (Δn_{xyz}) in a thickness direction represented by the equation below of at least 0.03 and is soluble in the methyl isobutyl ketone,
Δn_{xyz}=[(nx+ny)/2]−nz
where nx, ny and nz respectively represent refractive indices in an X-axis direction, a Y-axis direction and a Z-axis direction of a film when the non-liquid crystal polymer is formed into the film, with the X-axis direction being an axial direction exhibiting a maximum refractive index within a surface of the film, the Y-axis direction being an axial direction perpendicular to the X-axis direction within the surface and the Z-axis direction being a thickness direction perpendicular to the X-axis direction and the Y-axis direction.

2. The method according to claim 1, wherein the non-liquid crystal polymer is polyimide.

3. The method according to claim 2, wherein the polyimide comprises a repeating unit represented by the formula (1) below.

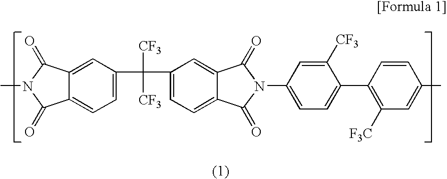

4. The method according to claim 3, wherein the polyimide has a weight-average molecular weight ranging from 10,000 to 1,000,000.

5. The method according to claim 2, wherein the polyimide comprises a repeating unit represented by the formula (2) below.

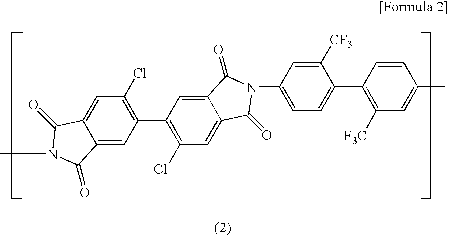

6. The method according to claim 5, wherein the polyimide has a weight-average molecular weight ranging from 10,000 to 1,000,000.

7. The method according to claim 1, wherein a ratio of the non-liquid crystal polymer dissolved in the solvent is at least 5 parts by weight of the non-liquid crystal polymer with respect to 100 parts by weight of the methyl isobutyl ketone.

8. The method according to claim 1, wherein the birefringent layer to be formed has a transmittance of at least 90% at a measurement wavelength of 590 nm.

9. The method according to claim 1, further comprising stretching the birefringent layer after forming the birefringent layer by hardening the formed coating film.

10. The method according to claim 9, wherein a uniaxial stretching treatment or a biaxial stretching treatment is carried out during the stretching.

11. The method according to claim 1, wherein a shrinkable transparent film is used as the transparent film, and the method further comprises shrinking the birefringent layer by shrinking the transparent film after forming the birefringent layer by hardening the formed coating film.

12. The method according to claim 11, wherein the transparent film is shrunk by heating.

13. An optical film produced by the method according to claim 1, comprising a laminate of a transparent film and a birefringent layer formed on the transparent film.

14. The optical film according to claim 13, further comprising a polarizer.

15. The optical film according to claim 14, wherein the polarizer is laminated on a side of the transparent film in the laminate, and the transparent film also serves as a transparent protective layer for the polarizer.

16. The optical film according to claim 13, further comprising a retardation plate.

17. The optical film according to claim 13, further comprising a reflector.

18. A liquid crystal panel comprising a liquid crystal cell and an optical member that is disposed on at least one surface of the liquid crystal cell, wherein the optical member is the optical film according to claim 13.

19. The liquid crystal panel according to claim 18, wherein the liquid crystal cell is at least one liquid crystal cell selected from the group consisting of an OCB mode, a VA mode and a TN mode.

20. The liquid crystal panel according to claim 18, wherein an optical compensation layer side of the optical film is arranged so as to face the liquid crystal cell.

21. A liquid crystal display comprising the liquid crystal panel according to claim 18.

22. An image display apparatus comprising the optical film according to claim 13.

23. An optical film comprising a laminate of a birefringent layer and a transparent film wherein
the birefringent layer comprises a birefringent material comprising a non-liquid crystal polymer that has a birefringence (Δn_{xyz}) in a thickness direction represented by the equation below of at least 0.03 and is soluble in the methyl isobutyl ketone,
Δn_{xyz}=[(nx+ny)/2]−nz
Where nx, ny and nz respectively represent refractive indices in an X-axis direction, a a Y-axis direction and a Z-axis direction of a film when the non-liquid crystal polymer is formed into the film, with the X-axis direction being an axial direction exhibiting a maximum refractive index within a surface of the film, the Y-axis direction being an axial direction perpendicular to the X-axis direction within the surface and the Z-axis direction being a thickness direction perpendicular to the X-axis direction and the Y-axis direction,
and the birefringent layer contains a methyl isobutyl ketone (MIBK) residue.

24. The optical film of claim 23, wherein the birefringent layer is formed directly on the transparent film.

25. The optical film of claim 23, wherein the transparent film is a TAC film.

26. The optical film of claim 23, wherein the MIBK residue is 1.0% or less.

27. The optical film of claim 23, wherein the MIBK residue is 0.5% or less.

28. A liquid crystal panel comprising the optical film of claim 23.

29. A liquid crystal display comprising the optical film of claim 23.

30. A liquid crystal display apparatus comprising the optical film of claim 23.
